(19) United States
(12) Patent Application Publication
(10) Pub. No.: US 2008/0037782 A1
(43) Pub. Date: Feb. 14, 2008

(54) REDUCTION OF CHANNEL CHANGE TIME FOR DIGITAL MEDIA DEVICES USING KEY MANAGEMENT AND VIRTUAL SMART CARDS

(75) Inventor: Glenn A. Morten, Bellevue, WA (US)

Correspondence Address: DARBY & DARBY P.C., P.O. BOX 770, Church Street Station, New York, NY, 10008-0770, US

(73) Assignee: Widevine Technologies, Inc., Seattle, WA (US)

(21) Appl. No.: 11/780,422

(22) Filed: Jul. 19, 2007

Related U.S. Application Data
(60) Provisional application No. 60/822,214, filed on Aug. 11, 2006.

(51) Int. Cl. H04N 7/167

(52) U.S. Cl. 380/239

(57) ABSTRACT

A method, apparatus, and system are directed towards reducing a channel change time contribution related to security for digital media devices by using key management and a virtual smart card. In one embodiment, Entitlement Control Messages (ECMs) used to provide access to content keys for decrypting of content are provided over the network to the digital media device at an increased frequency over traditional systems. In another embodiment, use of the virtual smart card is directed towards removing physical limitations that may arise due to the use of a physical smart card, separate secure microprocessor, or the like, and associated physical interface, thereby further reducing channel change times contributed to content protection components of the digital media device.

### CROSS-REFERENCE

This utility patent application claims priority to U.S. Provisional Patent Application No. 60/822,214, filed on Aug. 11, 2006, entitled “Reduction Of Channel Change Time For Digital Media Devices Using Key Management And Virtual Smart Cards,” the benefit of which is claimed under 35 U.S.C. §119, and is further incorporated herein by reference.

### TECHNICAL FIELD

This invention relates generally to digital communications, and more particularly but not exclusively, to reducing a channel change time contribution related to security for digital media devices using key management and a virtual smart card.

### BACKGROUND OF THE INVENTION

In today's digital media realm, the ability to quickly change from one digital channel to another channel on a digital media device, such as a personal computer, Set-Top Box (STB), or the like, is of major interest globally to many digital media operators. This is, in part, because, channel changing heavily influences a user's experience and overall customer satisfaction. However, the time it takes to change a channel is affected by numerous factors, including the type and capability of middleware, decoders, access equipment, network infrastructure, content protection systems, and the like, that may be employed, to name just a few. The selection of inappropriate components within a content protection system, for example, may have significant negative impacts on the time it may take to change channels, and thereby negatively affect a user's experience. Thus, it is with respect to these considerations and others that the present invention has been made.

### BRIEF DESCRIPTION OF THE DRAWINGS

Non-limiting and non-exhaustive embodiments of the invention are described with reference to the following drawings. In the drawings, like reference numerals refer to like parts throughout the various figures unless otherwise specified.

For a better understanding of the invention, reference will be made to the following Detailed Description of the Invention, which is to be read in association with the accompanying drawings, wherein:

FIG. 1 shows a functional block diagram illustrating an environment for practicing the invention;

FIG. 2 shows one embodiment of a digital media device that may be employed;

FIG. 3 illustrates functional block diagrams of one embodiment of digital media directional stacks;

FIG. 4 illustrates one embodiment of an example of a channel change timeline based on the digital media directional stacks;

FIG. 5 illustrates one embodiment of an example of a content security contribution to a channel change timeline;

FIG. 6 illustrates one embodiment of an example of a reduced content security contribution to a channel change timeline; and

FIG. 7 illustrates one embodiment of a virtual smart card useable to reduce channel change time, in accordance with the present invention.

### DETAILED DESCRIPTION OF THE INVENTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly, the present invention is directed towards a method, apparatus, and system for reducing a channel change time contribution related to security for digital media devices using key management and a virtual smart card. In one embodiment, Entitlement Control Messages (ECMs) used to provide access to content keys for decrypting of content are provided over the network to the digital media device at an increased frequency over traditional systems. In one embodiment, the ECMs may be inserted immediately before an intra-frame (I-frame) within a packet data stream. In one embodiment, the ECMs are provided to the digital media device at between at least about 10 to about 15 times or more per second. In one embodiment, the frequency may be selected to balance a bandwidth and a computational impact on a Set-Top Box (STB), Personal Video Recorder (PVR), personal computer, or similar digital media device.

In traditional systems, the ECMs are typically provided at about once or twice per second to once every few seconds. Increasing of the frequency of the transmission of the ECMs has the effect of enabling key management access to be improved. Use of the virtual smart card has the further effect of removing many of the physical limitations that may arise due to use of a physical smart card, separate secure microprocessors, or the like, and associated physical interfaces. By employing a virtual smart card to manage the decryption keys and related key management activities, channel change time may be further reduced. In particular, various embodiments of the invention are directed towards reducing channel change time contributions of content protection components within a digital media device to within speeds that substantially appear to be instantaneous to a human eye. In one embodiment, such speeds may be achieved that are below about 100 msec.

### Illustrative Environment

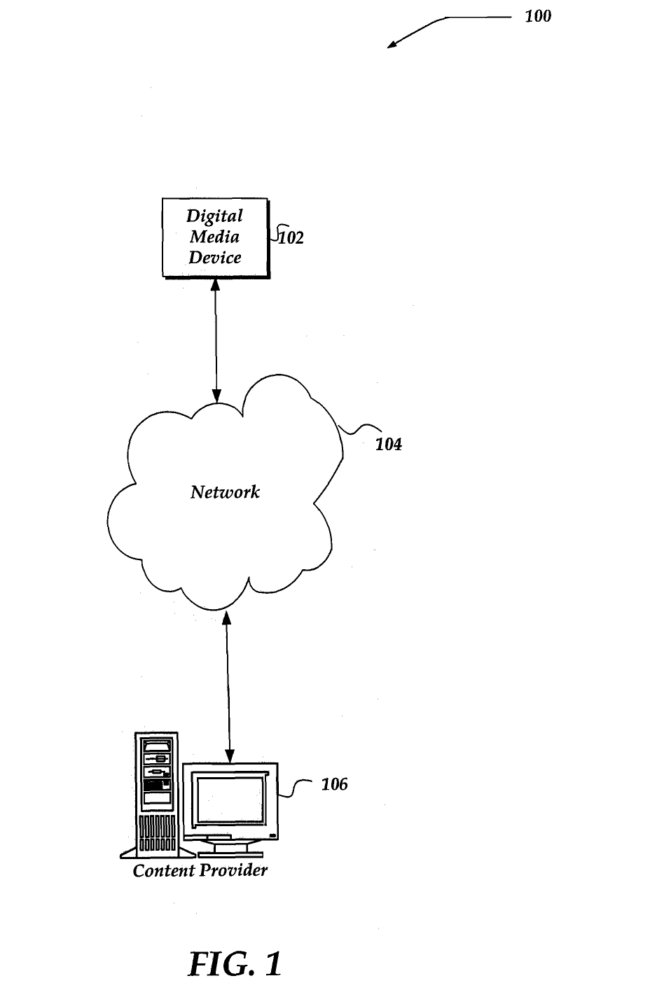

FIG. 1 is a functional block diagram illustrating an exemplary operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes a digital media device 102, a network 104, and a content provider 106. Network 104 is coupled to and enables communication between digital media device 102 and content provider 106.

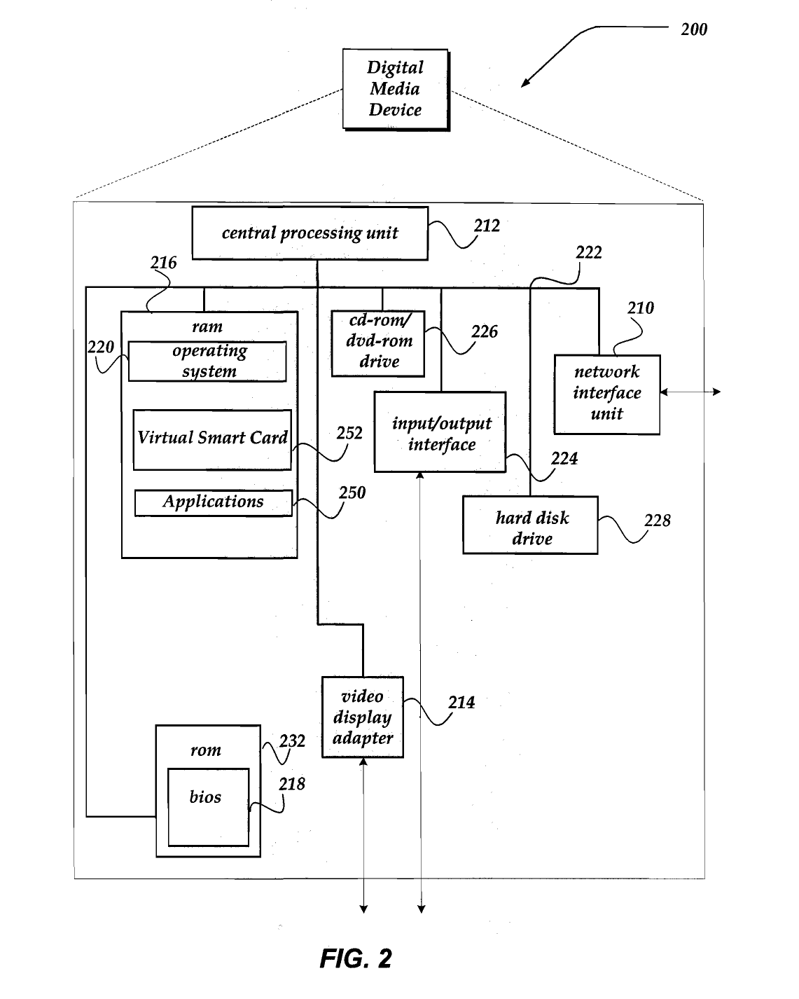

One embodiment of digital media device 102 is described in more detail below in conjunction with FIG. 2. Briefly, however, digital media device 102 may include virtually any computing device capable of receiving content and/or software over a network, such as network 104, from another computing device, such as content provider 106. Digital media device 102 may also include any computing device capable of receiving the content and/or software employing other mechanisms, including, but not limited to CDs, DVDs, tape, electronic memory devices, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Digital media device 102 may also be any device that is capable of connecting using a wired or wireless communication medium such as a PDA, POCKET PC, wearable computer, media players, and any other device that is equipped to communicate over a wired and/or wireless communication medium to receive and play the content. Similarly, digital media device 102 may employ any of a variety of devices to enjoy such content, including, but not limited to, a computer display system, an audio system, a jukebox, set top box (STB), PVR, a television, video display device, and the like.

Digital media device 102 may further employ virtual smart card (VSC) software as described below. Digital media device 102 may employ the VSC software, for example, to manage access to content. The VSC software can be renewed over a network by downloading at least a portion of the VSC software (including new encryption/decryption keys), or by receiving it via another mechanism. Although a VSC is described, it should be clear that virtually any downloadable Conditional Access System (CAS) software module may also be employed. In one embodiment, the VSC may also be configured to provide Digital Copy Protection (DCP). In one embodiment, the VSC may be configured as a unified downloadable CAS kernel and decryption module configured and arranged to provide reduced channel change times.

Network 104 is configured to couple one computing device to another computing device to enable them to communicate. Network 104 is enabled to employ any form of computer readable media for communicating information from one electronic device to another. Also, network 104 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 104 includes any communication method by which information may travel between networked devices.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Content provider 106 includes virtually any network device that may be employed by producers, developers, and owners of content for distributing content to digital media device 102. Such content includes pay-for-view or time and subscription television, movies, interactive video games, interactive news television, catalogue browsing, distance learning, video conferencing, and the like. It is apparent that such content owned by content provider 106 is not limited to video content only, and may include audio only services, without departing from the scope or spirit of the present invention. Thus, content is intended to include, but not be limited to, audio, video, still images, text, graphics, and other forms of content directed towards a user.

In one embodiment, the content is provided as a Moving Pictures Experts Group (MPEG) content stream, such as a transport stream, or the like. However, the invention is not so limited, and other file formats may also be employed. For example, the content may also be provided in H.262 format, H.264 format, H.323 format, Video Codec-1 (VC-1) format, or the like, without departing from the scope or spirit of the invention.

Briefly, MPEG is an encoding and compression standard for digital broadcast content. MPEG provides compression support for television quality transmission of video broadcast content. Moreover, MPEG provides for compressed audio, control, and even user broadcast content. One embodiment of MPEG-2 standards is described in ISO/IEC 13818-7, which is available through International Organization for Standardization (ISO), and is hereby incorporated by reference.

Briefly, MPEG content streams may include Packetized Elementary Streams (PES), which typically include fixed (or variable sized) blocks or frames of an integral number of elementary streams (ES) access units. An ES typically is a basic component of an MPEG content stream, and includes digital control data, digital audio, digital video, and other digital content (synchronous or asynchronous). A group of tightly coupled PES packets referenced to substantially the same time base comprises an MPEG program stream (PS). Each PES packet also may be broken into fixed-sized transport packet known as MPEG Transport Streams (TS) that form a general-purpose approach of combining one or more content streams, possible including independent time bases. Moreover, MPEG frames may include intra-frames (I-frames), forward predicted frames (P-frames), and/or bi-directional predicted frames (B-frames).

Moreover, the content may be distributed to various participants within operating environment 100 as selectively encrypted content. For example, in one embodiment, content provider 106 may selectively encrypt at least a portion of the content, while leaving another portion unencrypted. Content provider 106 may select to encrypt a video elementary stream (ES), an audio ES, a digital data ES, and/or any combination, and/or any portion of video, audio, data elementary streams of the content. In one embodiment, at least one portion of the content may be selectively encrypted using one content encryption key, while another portion of the content may be selectively encrypted using another content encryption key. It is noted, however, the content provider 106 may also select to encrypt all of the content, without departing from the scope or spirit of the invention.

Content provider 106 may further select to encrypt at least a portion of the content using any of a variety of encryption techniques, including, but not limited to RSA algorithms, Data Encryption Standard (DES), International Data Encryption Algorithm (IDEA), Skipjack, RC4, Advanced Encryption Standard (AES), Elliptic Curve Cryptography, or the like. Moreover content provider 106 may perform such encryption on-the-fly.

Content provider 106 may provide a decryption key that may be used to decrypt the selectively encrypted content, along with content attribute information, rights, and entitlements to access the content in an Entitlement Control Message (ECM). Briefly, an ECM is typically a packet which includes information to determine the decryption key, also known as the content key or control word, for use in decrypting the content. The decryption key may be encrypted with a service key and provided within the ECM message. In one embodiment, the ECM is provided in-band along with the selectively encrypted content.

The service key may be encrypted using an encryption key, herein referred to as an access key that may be specific to a recipient of the selectively encrypted content, and sent within a message frame, packet, or the like. For example, in one embodiment, the encrypted service key may be sent within an Entitlement Management Message (EMM). In one embodiment, the EMM may also include additional information such as subscription information, or the like, associated with the recipient. In one embodiment, at least some of the information within the EMM may be encrypted using any of a variety of symmetric encryption techniques, including, but not limited to AES, Twofish, Serpent, Blowfish, CASTS, RC4, TDES, IDEA, or the like. In one embodiment, the access key may be provided using an out-of-band mechanism. For example, the access key may be provided using any of the variety of portable storage devices described below, out-of-band over a network, via a virtual smart card, or the like.

In any event, devices that may operate as content provider 106 include personal computers, desktop computers, multiprocessor systems, microprocessor-based or programmable consumer electronics, network PCs, servers, and the like. Such network devices typically include a transceiver component, such as a network interface unit, transceiving device, or network interface card (NIC), such as described below with respect to digital media device of FIG. 2. Moreover, such network devices typically also include a processor, such as might be described in FIG. 2, that is configured to receive data and computer-executable instructions that when loaded within the processor cause the processor to perform a variety of actions, including, but not limited to encrypting content, and/or providing ECMS, EMMS, and/or encrypted content over a network, as well as receiving channel change instructions from digital media device 102, and/or providing responses to the instructions that may include, but are not limited to changes in ECMS, EMMs, and/or provided content.

### Illustrative Digital Media Device

FIG. 2 shows one embodiment of a digital media device that may be employed in the operating environment 100 of FIG. 1. Digital media device 200 may include many more or less components than those shown. The components shown, however, are sufficient to disclose an illustrative embodiment for practicing the invention.

Digital media device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of digital media device 200. Any general-purpose operating system may be employed. Basic input/output system (“BIOS”) 218 is also provided for controlling the low-level operation of digital media device 200. As illustrated in FIG. 2, digital media device 200 also can communicate with the Internet, or some other communications network, via network interface unit 210, which is constructed for use with various communication protocols including the TCP/IP protocol. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs may include transcoders, schedulers, calendars, database programs, CODECs, networking programs, media communication stacks, user interface programs, encryption/decryption programs, security programs, content programs, account management programs, and so forth. Application programs may also include virtual smart card (VSC) 252. In another embodiment, VSC 252 may be configured and arranged to operate as a unified downloadable CAS kernel and decryption module. In one embodiment, VSC 252 may be further configured to provide digital copy protection.

VSC 252 includes computer-executable code, data, decryption/encryption keys, and the like, that is configured to enable digital content protection similar to physical smart card approaches. However, unlike the physical smart card approaches, the VSC 252 is configured as software that may be downloaded to and reside within digital media device 200 to enable changes in security solutions to be implemented rapidly (in seconds, minutes, or hours) at relatively low costs. This is in stark contrast to physical smart card approaches, separate secure microprocessor implementations, or the like, that often require new hardware to be generated and distributed. Such physical approaches typically are made available as updates about once or twice a year. Moreover, use of the VSC 252 removes physical constraints on content protection layers providing the secure content to a user. For example, by replacing a physical smart card, separate microprocessor, or the like, with the VSC 252, physical interface cards, links, or the like, may be removed. Removal of such physical components from digital media device 200 is directed at improving a channel change time over traditional systems, as well as overall communication timelines for content enjoyment.

Use of the described VSC 252 also enables privacy (confidentiality), integrity, timeliness, access control (authorization), and authentication (identity), as well as rapid renewal, cross link copy protection or digital rights management, and greater capacity, flexibility, and an ability to bind to a device to provide increased security.

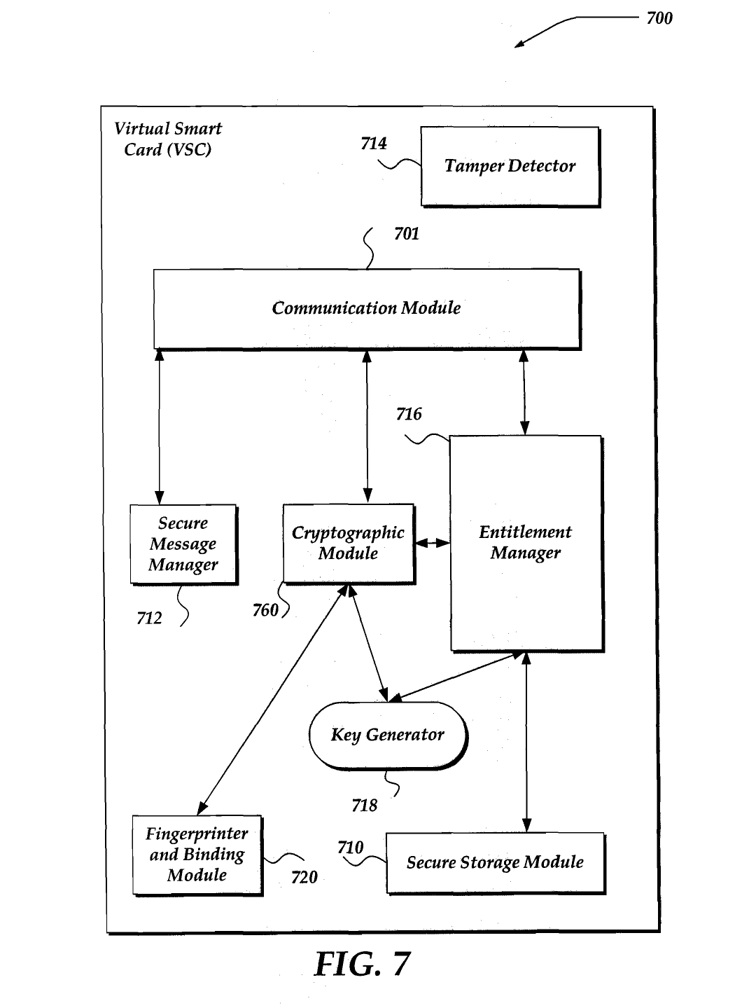

VSC 252 software may include various components including but not limited to secure stores, fingerprinting modules, secure message managers, entitlement managers, key generators, and the like. The VSC 252, and its components, may be configured to enable protection of received content. In one embodiment, the VSC 252 may be configured, in part, to generate a decryption key for use in decrypting received content. In another embodiment, the VSC 252 may receive the decryption key from another device, or component, within the client device, over a network, from a portable memory device, or from a variety of other mechanisms. In one embodiment, VSC 252 may receive ECMs or the content key, and use the received content key to decrypt the encrypted content. Thus, VSC 252 may be configured to decrypt the ECM, employ EMMs to determine access rights, or the like, encrypt the encryption keys (control words), and provide them to an internal (to VSC 252) decryption subcomponent, thereby reducing distribution of such actions across a plurality of hardware based components and/or hardware interfaces. One embodiment of VSC 252 is illustrated in FIG. 7.

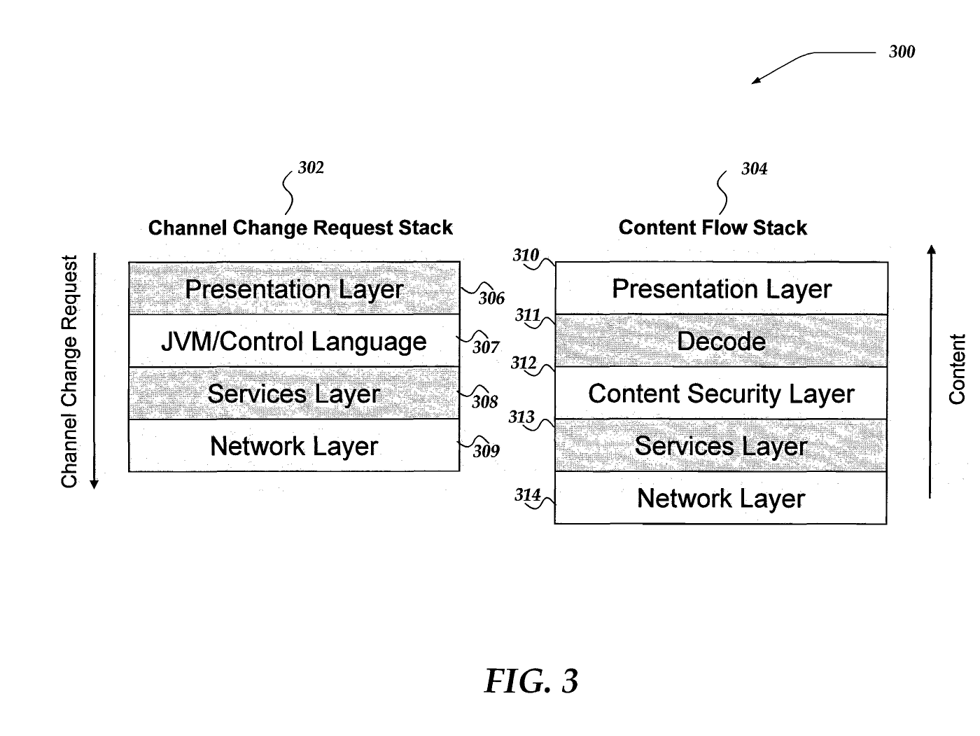

FIG. 3 illustrates functional block diagrams of one embodiment of digital media directional stacks. As shown, stacks 300 include channel change request stack 302 and content flow stack 304. These represent embodiments of two directional stacks that may be employed in managing sending and receiving of digital media content over a network, such as network 104 of FIG. 1.

As shown, channel change request stack 302 includes a presentation layer 306, a control layer 307, a service layer 308, and a network layer 309. When information, such as a request to change a channel on the digital media device is received, it is first typically received at the presentation layer 306. The request is then passed down to the control layer 307. In one embodiment, the control layer 307 may include a Java Virtual Machine, or other control language interface application. The control layer 307 may modify the request and pass the modified request down to the services layer 308, which may further modify the request and provide the request to the network layer 309 for transmission over a network. In one embodiment the modified request is provided to such as content provider 106 of FIG. 1 over network 104.

The response to the request to change the channel, or other action, may be received through content flow stack 304. The response may first be received through the network layer 314 of the content flow stack 304, modified, and provided up through services layer 313, to content security layer 312. Content security layer 312 may then examine access control rights and entitlements to determine whether to allow access to the received response. If it is determined that access is allowed, the response may then be provided to the decode layer 311 where it may be decompressed, or otherwise decrypted and/or descrambled using decryption keys. The decrypted response may then be provided to the presentation layer 310 of content flow stack 304, where in this example, a channel change may occur.

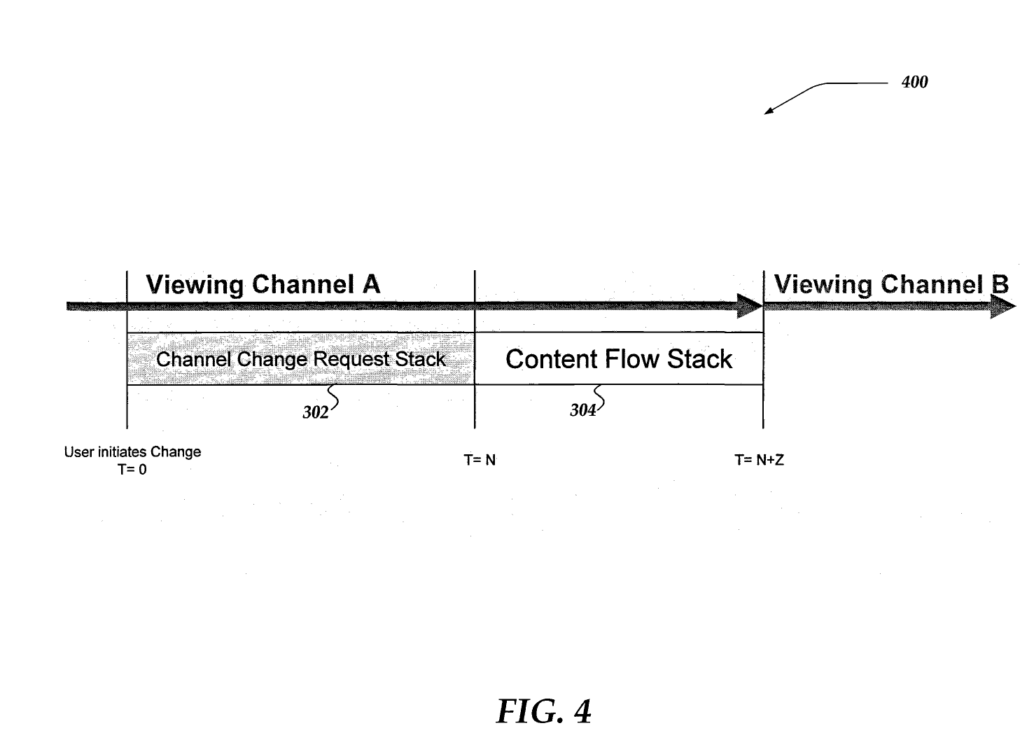

FIG. 4 illustrates one embodiment of an example of a traditional channel change timeline based on the digital media directional stacks. As shown in timeline 400 of FIG. 4, each of the digital media directional stacks contribute to a channel change timeline. As may be seen, within each stack the different components add to the timeline. However, this invention is directed towards minimizing a contribution to the channel change time made by the content security layer 312. In a typical digital television channel change, it may take several seconds for a change in channels. The content security layer 312 typically may contribute as much as 4 seconds to the total overall channel change time in traditional implementations.

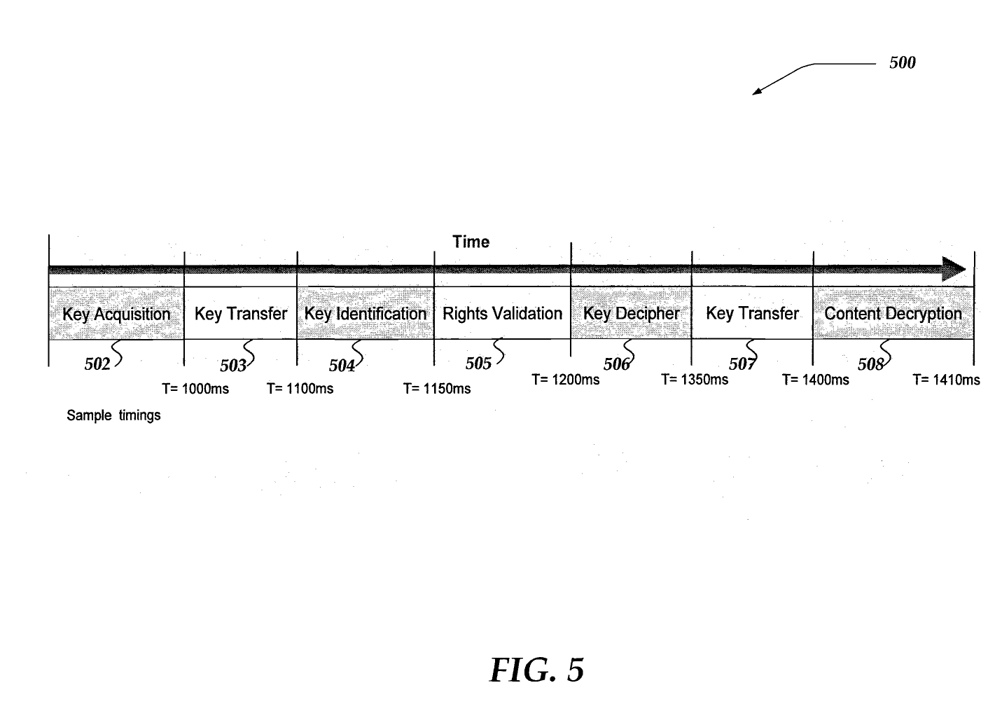

FIG. 5 illustrates one embodiment of an example of a typical content security contribution to a channel change timeline. Timeline 500 of FIG. 5 provides a brief explanation of steps within the content security layer 312 that may add seconds to a typical channel change time.

As shown, in one embodiment, the content security layer timeline 500 may include seven steps: key acquisition 502, key transfer 503, key identification 504, rights validation 505, key decipher 506, key transfer 507, and content decryption 508.

In key acquisition 502 a key or control word is used to decipher the content before decompression. The proper key must be obtained as the first step. In conditional access systems (CAS) the content keys are often in-band with the content in a message called an ECM. This ECM may be retrieved from the content stream.

The next step, key transfer 503, includes the time in transferring the content key from the content, or some other delivery mechanism to the content security kernel so it may be decrypted for use. In conditional access systems the content keys are often in-band with the content in the ECM, which are transferred to the CAS kernel for further processing.

Key identification 504 is the next step in the process where the CAS kernel identifies the key or algorithm used to decipher the content key. From there, rights validation 505 occurs where the rights to the consumption of the content are verified prior to content decryption 508. The next step involves key decipher 506 (once the rights are verified (step 4) and the content key is unlocked (using the key or algorithm from step 3) for use in further content processing). Then step 6, key transfer 506, occurs where the content key is securely transferred to a component which performs content decryption. In many implementations, this component has been a physical smart card or other hardware/firmware based component. The last step (step 7) is content decryption 508, where the content is decrypted and may then be consumed. As can be seen in FIG. 5, in traditional content security systems significant time may be consumed in these steps.

In the step of Key acquisition 502, for traditional solutions the ECM are often inserted infrequently in the content stream. This insertion traditionally ranges from about once or twice per second to once every few seconds. In another embodiment, the ECM is passed through the channel change request stack 302 to the content security layer 312. The time to the next ECM typically dramatically impacts channel change time.

In the step of Key Transfer 503, when transferring the ECM to the CAS kernel, traditional systems typically may involve multiple physical and logical components that often include a relatively slow interface to a physical smart card, separate microprocessor, or the like. This step may dramatically impact channel change time.

With respect to the step of Key Identification 504, traditional systems often use resource constrained physical cards, microprocessors, or the like, for storing and lookup of keys. This step typically does not a significant contributor to the timeline. Further, in the rights validation step 505, traditional systems often use resource constrained physical cards, microprocessors, or the like, for Rights validation 505. This step typically may not be a significant contributor to the timeline. In the Key Decipher 506, traditional systems often use resource constrained physical cards for deciphering keys. This step traditionally dramatically impacts channel change time. For the Key Transfer 506, when transferring the content key to the content decryption function, traditional systems involve multiple physical and logical components that often include a relatively slow interface to a physical smart card, separate microprocessor, or the like. This step therefore, may typically dramatically impact channel change time. Moreover, for Content Decryption 508, this step typically appears not to be a significant contributor to channel change time. In particular, as shown in FIG. 5's example timeline, key acquisition 502 may consume as much as about 70% of the overall time for the content security layer 312.

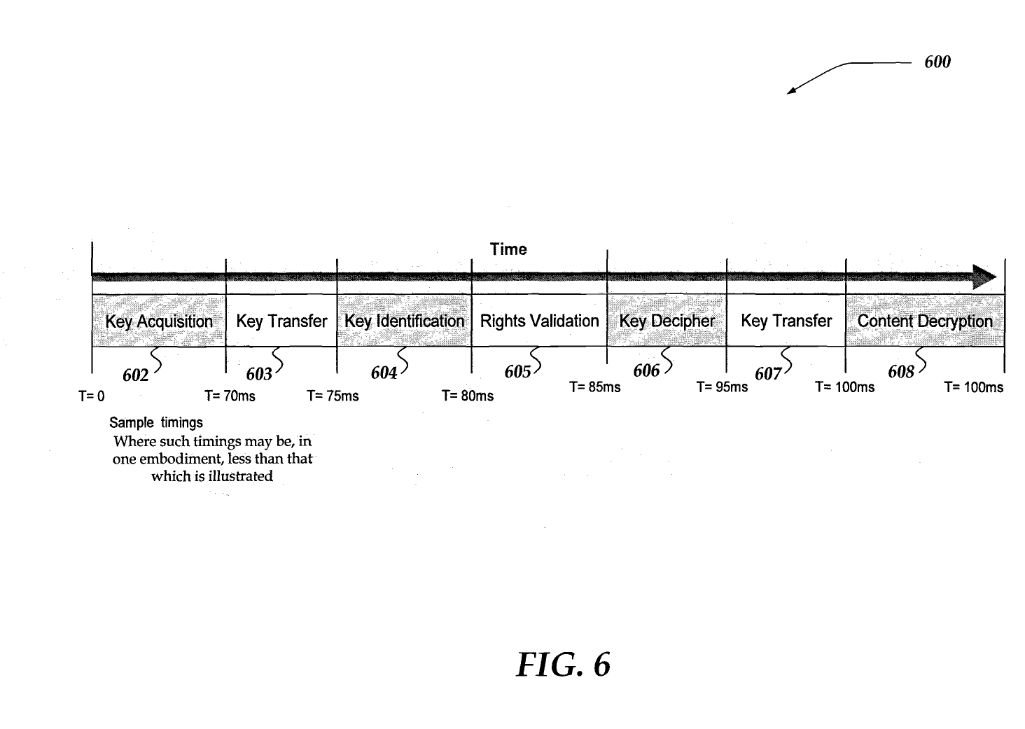

FIG. 6 illustrates one embodiment of an example of an improved content security contribution to a channel change timeline. As shown in FIG. 6, timeline 600 illustrates a significant time reduction may be achieved by the following.
1. Key Acquisition 602: In this invention ECMs are inserted at an increased frequently in the content stream. In one embodiment, the ECMs may be inserted between about 10 times per second to about 15 times per second. However, the invention is not so limited, and other values may also be used. For example, it should be noted that ECMs can also be inserted and provided over a network at 9 times per second, or the like. Thus, the term “about” is intended to acknowledge that frequencies within a reasonable range of 10 times per second are also contemplated by the invention. In one embodiment, the ECMS may be inserted immediately prior to an I-frame within the content stream. This may bring acquisition time well less than 100 ms without a significant bandwidth increase.
2. Key Transfer 603: In this invention a virtual smart card (such as a downloadable content security) architecture is used. In this architecture the key transfer function may be eliminated or reduced in time by performing function 1, 3, 4, 5, and 7 within the digital media device and possibly in the same logical virtual smart card module. This makes step 2 essentially instantaneous.
3. Key Identification 604: In this invention the virtual smart card architecture is also used. In this architecture the key identification function may be reduced in time by performing function 3 by the virtual smart card within digital media device. This makes step 3 essentially instantaneous.
4. Rights Validation 605: In this invention the virtual smart card architecture is also used. In this architecture the Rights Validation function may be reduced in time by performing function 4 by the virtual smart card within the digital media device. This makes step 4 essentially instantaneous. Moreover, in one embodiment, rights validation 605 may employ any of a variety of symmetric encryption/decryption techniques including, but not limited to those described above.
5. Key Decipher 606: In this invention the virtual smart card architecture is used. In this architecture the Key Decipher function may be reduced in time by performing function 5 by the virtual smart card within the digital media device. This makes step 5 essentially instantaneous. In one embodiment, key decipher 606 may be based on any of a variety of symmetric encryption/decryption techniques, including, but not limited to those described above. Use of symmetric encryption/decryption techniques may further reduce time consumed within this step over approaches that employ asymmetric encryption/decryption techniques. For example, in one embodiment, key decipher 606 may be reducible to within about 5 milliseconds, or less, using symmetric over asymmetric encryption/decryption techniques. However, it should be noted, that the invention is not constrained to using symmetric encryption/decryption techniques, and asymmetric techniques may also be employed.
6. Key Transfer 607: In this invention the virtual smart card architecture is used. In this architecture the key transfer function may be eliminated or reduced in time by performing function 1, 3, 4, 5, and 7 by the virtual smart card within the digital media device and possibly in the same logical module. This makes step 6 essentially instantaneous.

Thus, as described above, by increasing a frequency of transmissions of ECMs and by replacing a physical CAS, such as a physical smart card, separate microprocessor, or the like, and their physical interfaces, with a virtual smart card, the overall content security layer's impact to a channel change timeline may be reduced over a traditional channel change timeline. In one embodiment, times consumed in performing functions 603, 604, and 607, may be reducible using the present invention to about one millisecond each, or less. Thus, the timings illustrated in FIG. 6 are intended to illustrate one embodiment of sample timings, and is not intended to limit or otherwise constrain the invention. For example, as noted, at least some of the time consumed by various functions shown in FIG. 6 may be less than the times illustrated in FIG. 6.

FIG. 7 illustrates one embodiment of a possible virtual smart card (VSC). VSC 700 of FIG. 7 may include many more components than those shown. The components shown, however, are sufficient to disclose an illustrative embodiment for practicing the invention, and variations in the arrangement and type of the components may be made without departing from the spirit or scope of the invention. Moreover, although VSC 700 is described, other downloadable conditional access system software modules may also be employed. As noted above, VSC 700 may be configured and arranged to operate as a unified downloadable CAS module within decryption and DCP capabilities, integrated within.

Use of VSC 700 enables privacy (confidentiality), integrity, timeliness, access control (authorization), and authentication (identity), rapid renewal, cross link copy protection or digital rights management, and greater capacity, flexibility, and an ability to bind to a device to provide increased security.

As shown, VSC 700 includes tamper detector 714, communication module 701, cryptographic module 760, entitlement manager 716, secure message manager 712, key generator 718, fingerprinter/binding module 720, and secure storage module 710.

Secure storage module 710 is configured to provide a secure local store that may include content that is tightly bound to the digital media device. Binding to the digital media device may be performed using, for example, a fingerprint, hash, or the like. Moreover, local security may be provided using encryption, obfuscation, or through use of various network resources. In one embodiment, secure storage module 710 may receive and securely store content decryption keys from an ECM, or the like.

Secure storage module 710 may also be configured to store content whether encrypted and/or decrypted. Thus, VSC 700 may enable decryption of at least a portion of the content to remain protected from unauthorized copying, or other unauthorized access, by maintaining the decrypted portion of the content within secure storage module 710, until at least the content is to be consumed by the digital media device, or is to be purged, or such similar action.

Fingerprinter/binding module 720 is configured to provide a fingerprint that uniquely identifies the digital media device. A fingerprint may be made up of a number of elements specific to each fingerprint. Such elements are termed herein as ridges. Each ridge includes an element of a fingerprint that provides information to the fingerprint making it unique from other fingerprints. Some examples of ridges include a hardware serial number, operating system version number, Internet Protocol address, physical memory size, and the like. Each ridge included within the fingerprint refines the identity of the system so that it may be uniquely identified within a system. The combinations of all fingerprints may create a handprint or system fingerprint that uniquely identifies a personal computer, server, client device, set top box, or similar device within the system. An order of each of the fingerprint groups and individual ridges may affect the resulting system fingerprint or handprint.

Key generator 718 is configured to employ cryptographic module 760 to enable generation of cryptographic keys. Such generation may employ for example, a rapid renewal mechanism whereby the new generation of keys may be performed within a short period of time, compared to traditional physical smart card, and/or separate microprocessor, key replacement mechanisms. In one embodiment key generator 718 may enable generation of new keys within hours rather than days, weeks, or even months. In one embodiment, to further obfuscate a potential point of attack dynamic rapid renewal is employed, wherein regeneration of keys, and the like, is performed on a random basis to create an unpredictable environment. In another embodiment, such dynamic rapid renewal may also be employed to replace various software components that may further minimize an attack. Employing such rapid renewal of enables use of VSC 700 in a variety of other situations, including banking, enterprise security, e-commerce, and by studios for content distribution, as well as managing streaming media content using content keys.

Tamper detection 714 may be applied at a variety of points within VSC 700 to ensure a highly secure infrastructure. Typically, some level of tamper protection or resistance may be provided as part of the software and/or hardware of VSC 700. As shown, tamper protection 7014 may provide protection or resistance from tampering, and similar hacking approaches. This protection may further include agents that are configured to perform various actions, including in-circuit emulator detection, debugger detection, debugger resistance, memory space violation detection and protection, as well as similar application level piracy behavior detection and protection.

Tamper detection 714 may be configured to identify tampering from other systems, such as those on a digital media device, and the like. For example, in an interactive television environment it may be possible to deploy tamper detection within a network to monitor for cloning attempts of virtual smart cards and/or its various components. Tamper detection 714 may further provide a trusted time source, thereby preventing replay attacks.

Cryptographic module 760 is configured to provide a variety of cryptographic keys, including symmetric or private keys, asymmetric or public keys, and the like. Although cryptographic module 760 may employ virtually any cryptographic mechanisms, in one embodiment, cryptographic module 760 employs AES for symmetric cryptography. In another embodiment, cryptographic module 760 employs RSA for asymmetric cryptographic actions.

Secure message manager 712 is configured to provide a secure medium for message exchange. Although not illustrated, secure message manager 712 may interact with a variety of other components of VSC 700 as required to ensure that mutual authentication of end parties is accomplished and privacy of messages is maintained.

Entitlement Manager 716 is configured to manage the receipt, storage, sending, and interpretation of ECMs, and similar entitlements. As such, entitlement manager 716 may perform various actions associated with security control activities as described above. For example, token manager 716 may receive ECMs and manage the key acquisition, key transfer, key identification, rights validation, key decipher, and content decryption steps described above. Moreover, entitlement manager 716 may employ secure message manager 712 to enable secure communications between a server and the digital media device.

Communication module 701 is configured to enable communications of content, and/or ECMs between VSC 700 and the digital media device, a network, or the like. Communication module 701 may then provide the content and/or ECMs to various components within VSC 700 for performance of various content security layer actions, as described in more detail above.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method of managing a channel change time, comprising:
providing, to a digital media device, Entitlement Control Messages (ECMs) at a frequency of at least ten times per second; and
employing a virtual smart card or a downloadable conditional access system within the digital media device to access the ECMs for use in performing content security decryption of content by the virtual smart card or a downloadable conditional access system, to reduce a time to change a channel on the digital media device.

2. The method of claim 1, wherein at least one ECM is inserted into a content stream immediately prior to an intra-frame (I-frame).

3. The method of claim 1, wherein the virtual smart card or downloadable conditional access system is configured and arranged to provide integrated conditional access and decryption services within the virtual smart card.

4. The method of claim 1, wherein the virtual smart card is configured to be downloadable onto the digital media device.

5. The method of claim 1, wherein the virtual smart card or a downloadable conditional access system is configured and arranged to perform actions, further comprising:
receiving the ECMs within the virtual smart card;
identifying a decryption key for use in decrypting received content;
validating digital rights associated with access to the received content; and
if the digital rights are validated for the received content, employing the decryption key to decrypt the received content and providing the decrypted content to another component for playing of the decrypted content.

6. The method of claim 1, wherein the virtual smart card or downloadable conditional access system is further configured to store received content within a secure store that is arranged to minimize unauthorized access to at least a portion of decrypted content.

7. The method of claim 1, wherein the virtual smart card is configured and arranged to provide a fingerprint that uniquely identifies the digital media device.

8. The method of claim 1, wherein the virtual smart card or downloadable conditional access system is configured to minimize an amount of time consumed within at least a key transfer step within a content security contribution to a channel change time.

9. A network device for use in managing over a network a channel change time at a digital media device, comprising:
a transceiver for sending and receiving data over the network; and
a processor that performs actions, including:
sending selectively encrypted content over the network to the digital media device; and
sending over the network, to the digital media device, Entitlement Control Messages (ECMs) at a frequency of at least about 10 times per second, wherein the digital media device employs a virtual smart card to access the ECM for use in performing content security decryption of content received over the network to reduce a time to change a channel on the digital media device, and enabling the content to be played.

10. The network device of claim 9, wherein at least one ECM is inserted into a content stream immediately prior to an intra-frame (I-frame).

11. The network device of claim 9, wherein the virtual smart card is further configured to provide digital copy protection of the received content.

12. The network device of claim 9, wherein the virtual smart card is configured and arranged to perform actions, further comprising:
receiving the ECMs within the virtual smart card;
obtaining a decryption key based on at least one of the received ECMs;
employing the decryption key to decrypt the received content; and
providing the decrypted content to another component for playing.

13. The network device of claim 9, wherein at least one ECM includes a decryption key different from another decryption key within another ECM, and the decryption key and other decryption key are configured to decrypt different portions of the received content.

14. The network device of claim 9, wherein the virtual smart card is configured to be a software module that is downloadable onto the digital media device over the network.

15. The network device of claim 9, wherein sending the selectively encrypted content or at least one ECM is based on the network device receiving a channel change request from the digital media device.

16. A system for use in managing a channel change time, comprising:
a server that is configured and arranged to perform actions, including:
providing, over a network, Entitlement Control Messages (ECMs) at a frequency of at least ten times per second;
providing content over the network, wherein the content is selectively encrypted using at least one control word provided within the ECMs; and
a digital media device, comprising:
a transceiver that is configured to receive content over the network; and
a downloadable conditional access system that is arranged to perform actions, including:
receiving the ECMS;
receiving the selectively encrypted content; and
decrypting the selectively encrypted content using the at least control word within the received ECMS, wherein the downloadable conditional access system reduces a time to change a channel on the digital media device.

17. The system of claim 16, wherein at least one ECM is provided over the network within the provided content, and wherein the at least one ECM is provided immediately prior to an I-frame within the content.

18. The system of claim 16, wherein providing at least one of the content or at least one ECM by the server is in response to receiving, from the digital media device, a channel change request.

19. The system of claim 16, wherein a content of at least one ECM is different from a content of at least one other ECM based on the server having received a channel change request from the digital media device.

20. The system of claim 16, wherein the downloadable conditional access system is configured as a virtual smart card.

21. The system of claim 16, wherein the downloadable conditional access system is arranged to perform actions, including:
receiving at least one Entitlement Management Message (EMM); and
decrypting information within the EMM using a symmetric decryption technique.
